(19) United States
(12) Patent Application Publication
(10) Pub. No.: US 2011/0057345 A1
(43) Pub. Date: Mar. 10, 2011

(54) IMITATION STONE SIDING SYSTEM

(76) Inventors: RICK JAMES MORSE, Grass Lake, MI (US); David H. Beck, Grass Lake, MI (US)

(21) Appl. No.: 12/947,233

(22) Filed: Nov. 16, 2010

Related U.S. Application Data
(62) Division of application No. 10/892,839, filed on Jul. 16, 2004, now abandoned.

(51) Int. Cl. B28B 7/00; B28B 17/00; B28B 13/02; B28B 1/00

(52) U.S. Cl. 264/40.1; 264/78; 425/98

(57) ABSTRACT

Imitation stone (102) and a section of siding (100) are formed in a mold cavity (202) with a surface that follows a topography (206) of each of one or more natural stones (204), applying pigments (300a), (302a), (304a) and (306a) at different locations on the mold cavity (202) to replicate different colors of each natural stone (204) and to replicate a distribution of the different colors at different locations on the topography (206); and forming an imitation stone material in the mold cavity (202) to replicate the topography (206) of each natural stone on the imitation stone material, and to transfer the pigments (300a), (302a), (304a) and (306a) to the imitation stone material.

### CROSS-REFERENCE TO RELATED APPLICATION

This application is a division of U.S. patent application Ser. No. 10/892,839, filed Jul. 16, 2004 (D0932-00430) which is expressly incorporated by reference herein in its entirety.

### FIELD OF THE INVENTION

The invention relates to imitation stone and to imitation stone siding for application to a building or other architectural structure. Further the invention relates to a system for manufacturing the imitation stone and the siding.

### BACKGROUND OF THE INVENTION

An imitation stone is manufactured from a material composition that is cast or molded. It is important that the imitation stone duplicate or imitate the aesthetic appearance of a wall laid up with natural stone. According to U.S. Pat. No. 5,634,307, a material composition for making imitation stone comprises a mixture of Portland cement and polymeric resins entrained with metallic particles or sand and pigments.

Other material compositions for making imitation stones are disclosed, by way of example, in U.S. Pat. Nos. 5,364,672 and 5,451,620. According to the patents, a matrix of thermoplastic resins and Portland cement are disclosed, to which fillers are added to simulate the aesthetic appearance of natural stone. For example, the patents disclose fillers in the form of aggregates of silica, sand, colored glass fragments and metal particles. The compositions are cast or molded into shapes that resemble quarried natural stone. Prior to the invention, random distributions of fillers and porosity in a matrix were relied upon to resemble natural stone.

Natural stones have color variations and a surface texture, which are aesthetic features that are difficult to replicate by imitation stone compositions. The features are not closely resembled by random distributions of fillers and porosity in the imitation stone compositions. What is needed is a process of controlling color variations and surface texture of manufactured imitation stones to replicate, more than merely resemble, the features of natural stones.

U.S. Pat. No. 6,113,995 discloses a process to create particular patterns of pigments in cast cementitious materials. Formulas are set for different imitation stone mixes. Specified amounts of different stone mixes are loaded into a three dimensional array within a holding container. Then the mixes are released from the container into molds where imitation stone patterns form according to the different mixes.

The imitation stone made by previous methods, did not replicate the features of actual natural stones. Accordingly, the imitation stone had many differences in appearance compared to the appearance of actual natural stones. Further, natural stones differ from one another, especially when mined from different quarries. Since the methods for making imitation stone prior to the invention did not replicate natural stone features, the differences among the natural stones could not be accurately replicated.

### SUMMARY OF THE INVENTION

The invention relates to an imitation stone siding, and a method for making the imitation stone siding without a need to arrange fabrication materials in random distributions or in controlled mixes.

According to the invention, a method is disclosed for manufacturing an imitation stone siding that replicates the features of actual natural stone, especially replicating different colors and replicating the surface texture or topography.

According to an embodiment of the invention, imitation stone is made by shaping a mold cavity with a surface that follows a topography of one or more natural stones. Pigments are applied at different locations on the mold cavity to replicate different colors of each natural stone and a distribution of the different colors at different locations on the topography. An imitation stone material is formed in the mold cavity to replicate the topography of each natural stone on the imitation stone material, and to transfer the pigments to the imitation stone material.

According to another embodiment of the invention, mapping data are obtained to correspond with different colors at different locations on the surface of each of the one or more natural stones. Accordingly, the mapping data replicates authentic height variations and authentic color variations of the surface of each of the one or more natural stones.

According to a further embodiment of the invention, a mold die is made by a machine controlled micro machining operation or selective etching operation using the mapping data as machine control data. Thus the mold die is made with a surface that follows the topography of each of the one or more natural stones.

Another embodiment according to the invention includes, a process step of making a pattern directly from the topography one or more natural stones. The pattern is made on a mold die. Thus the mold die is made with surface texture features of each of the one or more natural stones.

Another embodiment of a method according to the invention includes a process step of making one or more imitation stones in a mold, according to the following process steps. A mold is made with a mold topography that follows the topography of one or more natural stones. Pigments of different colors are applied to the mold topography, replicating the colors of each of the one or more natural stones at different heights of the stone's topography. Then imitation stone material is formed in the mold to transfer the imitated stone's topography to the imitation stone material. Further the pigments are transferred to the surface of the imitation stone material. Thereby, the method according to the invention produces one or more imitation stones that replicate the topography and surface texture of one or more natural stones. Further, each imitation stone replicates the color variations at different heights of the natural stone's topography, i.e., different colors at different heights.

A further embodiment of a method according to the invention includes a process step of making imitation stone in a mold, by transferring a replicating topography of the mold to imitation stone material that is formed in the mold, and transferring pigments on the mold to the imitation stone material to replicate the colors at different heights on the topography of each of one or more natural stones.

### BRIEF DESCRIPTION OF THE DRAWINGS

FIG. 1 is an elevation view of a section of imitation stone siding.

FIG. 2A is an isometric view of a mold die having a mold cavity for cast or molded imitation stone one of the imitation stones of an imitation stone siding.

FIG. 2B is a cross section view of a mold die being formed against the profile of a quarried natural stone.

FIG. 2C is a schematic view of a die for making a cast or molded imitation stone.

FIG. 2D is a fragmentary cut away view of an imitation stone.

FIG. 3A is a schematic view of an enlarged portion of the mold cavity of FIG. 2A, and disclosing different heights in the surface topography of the mold cavity, and further disclosing pigment being dispensed and applied to the surface topography.

FIG. 3B is a view similar to FIG. 3A, and further disclosing removing the pigment from shallower heights of the surface topography, while leaving pigment on the deeper heights of the surface topography.

FIG. 3C is a view similar to FIG. 3B.

FIG. 3D is a view similar to FIG. 3B, and illustrating different pigments on different levels of surface topography prior to molding a cast or molded imitation stone in the mold cavity.

### DETAILED DESCRIPTION OF THE INVENTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

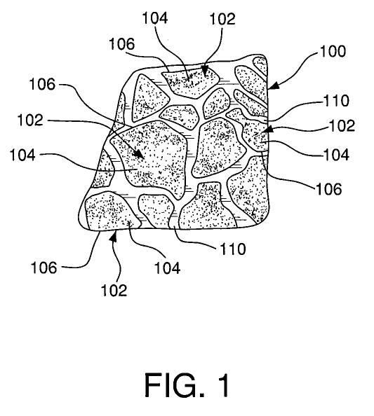

FIG. 1 discloses a section of imitation stone siding (100) having a number of individual imitation stones (102) each having a surface texture or topography (104) and an exterior profile (106). The imitation stones (102) are joined with imitation mortar joints (110). Prior to the invention, imitation stone was unable to replicate the surface texture and the color patterns of a natural stone's topography. Further, the section of imitation stone siding (100) is a panel that is assembled onto an architectural structure, such as, a building or wall.

According to the invention, a method is described for manufacturing each of the imitation stones (102) by replicating the actual surface texture or topography of each of one or more natural stones. Further, according to an embodiment of the invention, a method is described for manufacturing each of the imitation stones (102) by replicating the color variations and color patterns of a natural stone's topography. Each of the imitation stones (102) is a copy or replicate of an individual natural stone. The natural stone can have a weathered smooth surface or a quarried surface formed along quarrying fractures. Further, each imitation stone is a copy or replicate of the color variations at different heights of the natural stone's topography, i.e., different colors at different heights. Previous to the invention, imitation stone could merely imitate natural stone, without being a copy or replicate of the natural stone.

According to an embodiment of the invention, first, the surface topography of an individual natural stone is mapped, according to different colors at different heights of the topography. A scanning reflecting light microscope that is known in the industry scans the surface texture of an individual natural stone to create a data map of the surface texture. Such data maps can be displayed on a computer display terminal together with the different colors of the surface. The data maps are comprised of data representing different heights of the topography at different locations on the surface of the natural stone, together with additional data representing different colors at different heights of the topography. Thus, the data represents the topography and colors of the natural stone at different locations on the topography. Further, using the data, different pigments are selected to replicate the different colors of the natural stone. The pigments are used to color the imitation stones (102).

Alternatively, according to another embodiment of the invention, data mapping is conducted by manual observation and recording the observations as data. The surface topography of an individual stone is mapped by visual observation of the different colors at different heights of the topography. Written records of the visually observed different colors and topography are maintained as data representing the actual topography and actual colors of the natural stone.

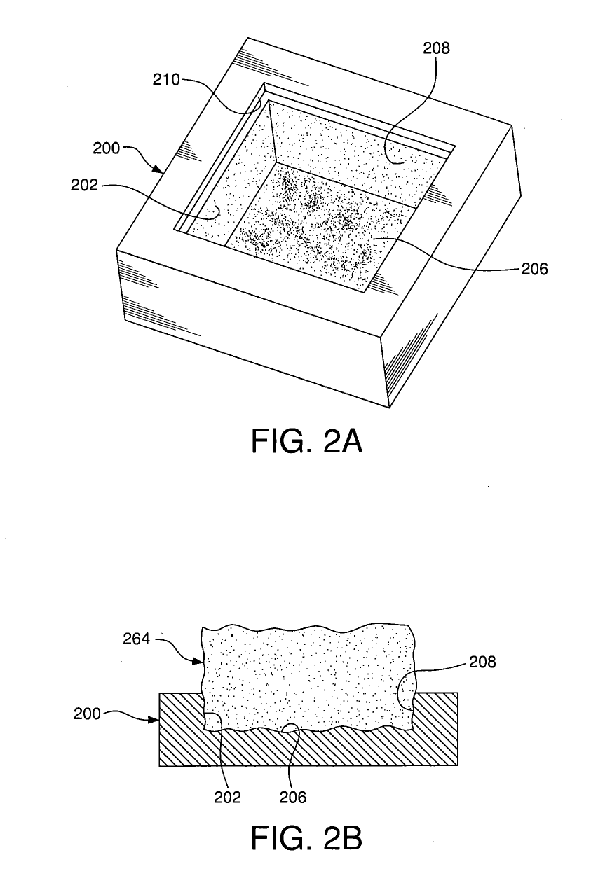

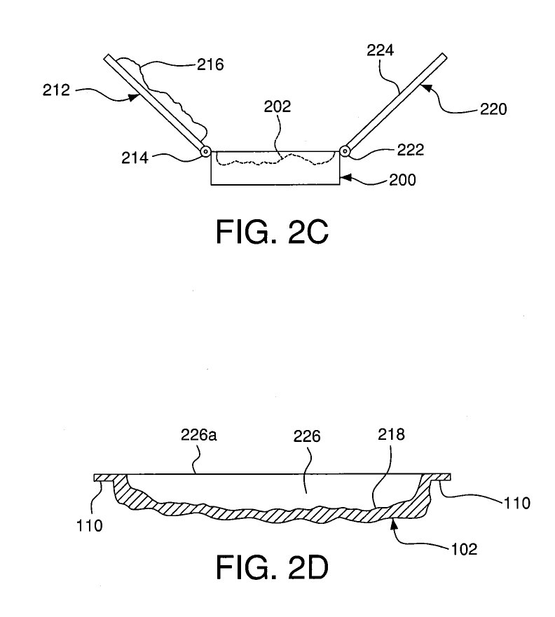

FIG. 2A discloses a mold die (200) made from a solidifiable material, including and not limited to: aluminum, aluminum alloy, steel, steel alloy, a metal, a metal alloy, epoxy, rubber, polymer, and combinations and compounds thereof. The mold die (200) has a mold cavity (202). With reference to FIG. 2B, and according to an embodiment of the invention, the mold cavity (202) has a surface that is shaped by forming the mold die (200), in the form of fluent material, directly against each of the one or more individual natural stones (204) to be replicated, followed by solidifying the fluent material. Thereby, shaping the surface of the mold cavity (202) directly against the one or more natural stones (204) imbeds the natural stone's topography in the surface of the mold cavity, causing the surface of the mold cavity (202) to follow the surface texture or topography (206) and the profile (208) of each of the one or more natural stones (204).

Alternatively, the surface of the mold cavity (202) of FIG. 2A is shaped by machine controlled, micromachining or selective etching, while using the data of the data map as control data to control the micromachining or selective etching. Thus, the invention includes many different embodiments or ways to make a mold cavity (202) and shape the mold cavity (202) with a surface that follows the natural stone's topography (206) and the periphery profile (208). Further, the invention can replicate natural stones (204) from the same quarry or from different quarries. Even the natural stones (204) from the same quarry differ from one another, and are replicated according to the invention.

Further, the mold cavity (202) includes a recess (210) around the replicated profile (208) for making an imitation mortar joint (110) at the profile (208) of an individual imitation stone (102). According to an embodiment of the invention, the depth of the mold cavity (202) is in a range of 0.25 inches to 3.0 inches. Although the mold cavity (202) is disclosed as replicating a single natural stone (204), the invention herein applies to a single mold cavity (202) that replicates one or more natural stones (204) in the same mold die (200). For example, the mold die (200) replicates one or more natural stones (204) to make a panel for siding (100) of various sizes, for example, in the range of 1 foot square to 4 feet by 10 feet rectangular. Further, for example, one or more natural stones (204) are replicated either with or without mortar joints (110) therebetween. When mortar joints (110) surround the natural stones (204) that are being copied or replicated, then the imitation mortar joints (110) are made as replicates of the mortar joints (110) surrounding the natural stones (204). Alternatively, when replicating one or more natural stones (204) that do not have mortar joints (110), the imitation mortar joints (110) can be created by shaping the mold cavity (202) with one or more recesses (210) to simulate mortar joints (110). Further, alternatively, the recesses (210) can be omitted from the mold cavity (202), to replicate a number of stones in a mortar free stone wall.

In practice, the entire section of imitation stone siding (100) having a number of individual imitation stones (102) can be made in a single mold cavity (202), by making the mold cavity (202) replicate a number of individual natural stones (204). According to another embodiment of the invention, recesses (210) are provided to form replicated mortar joints (108), that would resemble a laid-up stone wall. FIG. 1 discloses a section of imitation stone siding (100) having multiple imitation stones (102) arranged in a pattern. Both the pattern and the number of imitation stones (102) can vary. Thus, multiple sections of the siding (100) can be manufactured either as a single repeating pattern or as a number of different patterns.

FIG. 2C discloses an embodiment of a mold die (200) having the mold cavity (202). A first lid (212) is a first mating mold die (212) attached by a hinge (214) to the mold die (200). The first lid (212) is adapted to pivot about the hinge (214), clockwise, in FIG. 2C, to close the mold cavity (202) of the mold die (200). The first lid (212) has a first mold surface (216). When the first lid (212) is closed, the first mold surface (216) is spaced from the surface of the mold cavity (200) with a clearance in a range of about ¼ inch to 1 inch. A first imitation stone material is formed, for example, mold or cast, in the clearance, which forms a relatively thin but durable surface layer (218), FIG. 2D, of an imitation stone (102).

The first imitation stone material is, for example, a high density foamed polyurethane. For example, the first imitation stone material in a fluent state is injected into the clearance between the first mold surface (216) and the mold cavity (202), according to an injection molding operation, followed by molding the imitation stone material until it cures. Alternatively, the first imitation stone material is poured into the mold cavity (202), followed by, closing the first lid (212), according to a casting operation that casts the imitation stone material. The material is cured to a solidified state by the application of heat and by the application of pressure in the mold cavity (202) between the mold die (200) and the mating mold die (212). Following curing of the surface layer (218), the mold die (200) is opened by pivoting the first mating mold die (212) about the hinge (214), counter-clockwise in FIG. 2C. The formed and cured surface layer (218) remains in the mold cavity (202) while a further operation is performed by a second mating mold die (220).

FIG. 2C further discloses the second mating mold die (220) in the form of a second lid (220) attached by a hinge (222) to the mold die (200). The second lid (220) is adapted to pivot about the hinge (222), counter-clockwise in FIG. 2C, to close the mold cavity (202). The second lid (220) has a second mold surface (224). When the second lid is closed on the mold die (200), the second mold surface (224) is spaced from the surface of the mold cavity (202). Further, the second mold surface (224) is spaced from the formed and cured surface layer (218) that remains in the mold cavity (202). A second imitation stone material is formed, for example, molded or cast, to form an interior section (226), FIG. 2D, of the imitation stone (102). The second imitation stone material is, for example, a low density foamed polyurethane that bonds to the high density polyurethane surface layer (218) to form a unitary construction for an imitation stone (102).

For example, the second imitation stone material is either injected into the clearance between the closed second lid (212) and the mold cavity (202), or is poured into the mold cavity (202), followed by, closing the second lid (212). The second material composition is cured by the application of heat and pressure in the mold cavity (202) between the mold die (200) and the mating mold die (212) comprised of the second lid (212). Following curing of the interior section (226) to a solidified state, and bonding thereof to the surface layer (218), the mold die (200) is opened by pivoting the second mating mold die (220), clockwise in FIG. 2C, about the hinge (222). The imitation stone (102) thus formed will have a unitary construction of an inner section (226) bonded to a durable surface layer (218). A rear facing surface (226a) is substantially planar and adapted for facing toward a cementitious exterior grade wallboard. The imitation stone (102) is attached to the wallboard by industry known, exterior grade adhesive or mortar used for attaching siding to the wallboard.

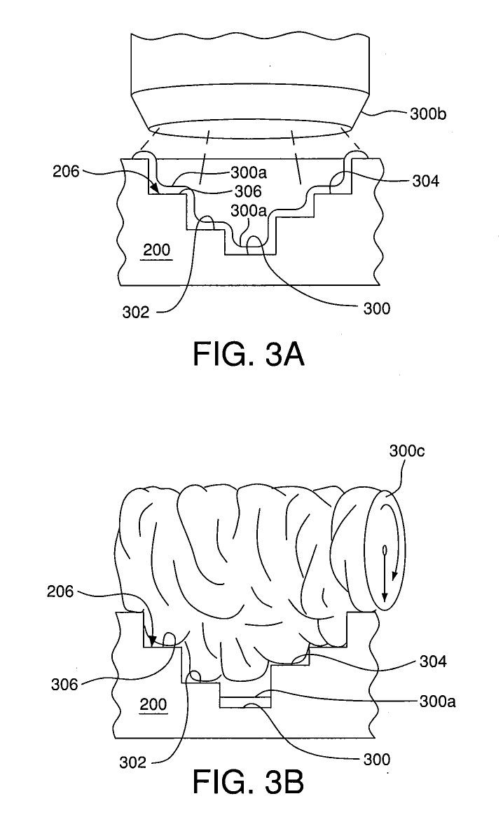

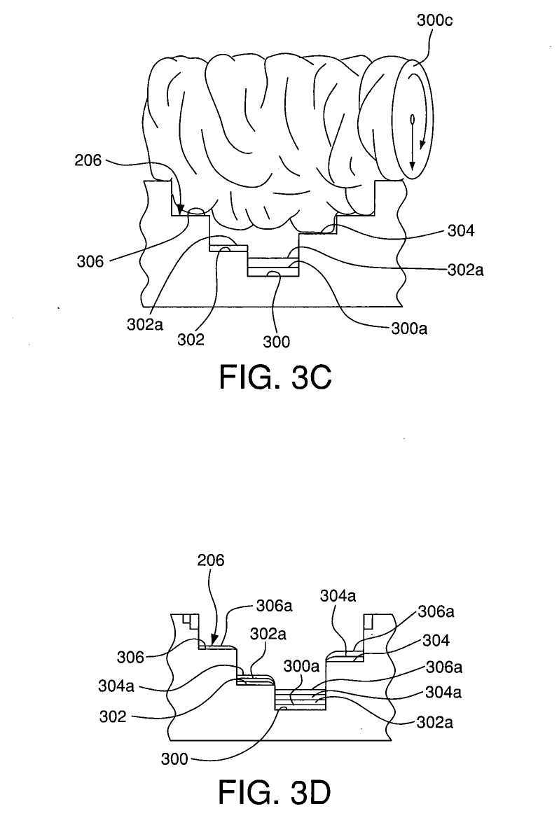

With reference to FIGS. 3A-3D, method steps will be described for copying or replicating different colors of the natural stone (204) at different locations on the natural stone's topography. The topography (206) disclosed by FIGS. 3A-3D is schematically depicted for purposes of description. The topography (206) of the mold cavity (202) will follow the natural stone's topography. The topography (206) is in the range of 0.1 cm in area and 0.1 cm deep.

With reference to FIG. 3A, a first pigment (300a) is applied to areas of deepest topography height (300) on the surface of the mold cavity (202). The area of deepest topography height (300) on the surface of the mold cavity (202) corresponds to an area of shallowest topography height on the surface of the imitation stone material that will be formed by the mold cavity (202). For example, the pigment (300a) is applied by a tool (300b), for example, a nozzle of a spray gun, a paint brush or paint roller or spreader. The color of the pigment (300a) is determined by the mapping data that identifies the color of the natural stone (204) at the topography height (300) of the natural stone (204). The mapping data may indicate that the natural stone (204) has different colors at different locations at the same topography height (300). Accordingly, the imitation stone is manufactured to replicate the different colors at different locations, by distributing different colors of pigment (300a) in respective spatter patterns, such that, the spatter patterns correspond to the distribution of different colors of pigment (300a) at the same topography height (300). For example, the spatter patterns are produced by spray patterns of a spray gun nozzle comprising one form of the tool (300b).

Since the pigment (300a) is desired to remain solely on the one topography height (300), excess pigment is removed from shallower heights (302), (304) and (306) of the topography. With reference to FIG. 3B, the excess pigment (300a) is removed by wiping the topography (206) with a cloth (300c) by applying a wiping motion and applying a normal force that urges the cloth (300c) into the depths of the topography (206). The normal force is sufficient to urge the cloth (330c) to the depth of the topography height (302) and not deeper. Then, following the wiping action, the pigment (300a) that has been applied, remains solely on the areas of deepest heights (300) of the topography (206).

With reference to FIGS. 3C and 3D, the step of applying pigments on different topography heights on the surface of the mold cavity (202) further includes, the alternating steps of, applying pigment (302a) to areas of shallower heights (302) of the topography (206), followed by the step of removing excess pigment (302a) from even shallower heights (304) and 306) of the topography (206), by applying a wiping action and a normal force in proportion to the penetration depth of the cloth (300c) into the depths of the topography (206). For example, the normal force is sufficient to penetrate the cloth (300c) into the depth of the topography height (304) and not deeper. Following the wiping action, the pigment (302a) remains solely on the area of topography height (302) and deeper. With further reference to FIG. 3D, the process steps are repeated until all the areas of topography heights (300), (302), (304) and (306) have respective pigments (300a), (302a), (304a) and (306a) applied on the surface of the mold cavity (202). The mold cavity (202) is ready to form an imitation stone (102) and to form an optional, imitation mortar joint (210) in the mold cavity (202), which will transfer the replicated natural stone's topography to the formed, cast or molded, imitation stone (102), and which will transfer the pigments (300a), (302a), (304a) and (306a) to the imitation stone (102), whereby the imitation stone (102) replicates the stone's topography and replicates the different colors of the natural stone and the distribution pattern of the different colors on the stone's topography. Further, when the pigments (300a), (302a), (304a) and (306a) are distributed in spatter patterns, they will replicate the distributions of the different colors of the natural stone (204) at different locations at the same topography height. Whereas, the pigments (300a), (302a), (304a) and (306a) are described, a larger number or smaller number of different pigments would be used, as determined by the mapping data that would identify the numbers of different colors to be replicated by different pigments. Further, the mapping data identifies the different colors at different heights in the topography of each natural stone.

When the durable surface layer (218) disclosed by FIG. 2D is formed in the mold cavity (202), the pigments are transferred to the durable surface layer (218), and are further adsorbed in the surface of the durable surface layer (218). Thus, the pigments (300a), (302a), (304a) and (306a) will resist being removed by weather erosion and by wear and tear.

According to a preferred embodiment of the invention, the in-mold pigment is a coating that chemically reacts with the material of the durable surface layer (218) during formation in the mold cavity (202) is available from Red Spot Paint & Varnish Co., Inc., Evansville, Ind., USA. The top layer or durable surface layer (218) is a polyurethane-polyurea hybrid foam forming material commercially available from Hehr International Polymers, Decatur, Ga., USA. The inner section (226) of the imitation stone is a brand name “Elastopor” polyurethane foam forming material commercially available from BASF Corporation, Mount Olive, N.J., USA. Fiber reinforcement and fire retardant are added to the materials of the surface layer (218) and the inner section (226) prior to formation in the mold cavity (202). For example, the fiber reinforcement comprises chopped glass strands commercially available from CertainTeed Corporation, Blue Bell, Pa., USA. The fire retardant is an iso- or di- or tri-propanolamine commercially available from Dow Chemical Company, Midland, Mich., USA.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for manufacturing imitation stone, comprising:
shaping a mold cavity with a mold cavity topography that follows a topography of each of one or more natural stones;
applying pigments of different colors on the surface of the mold cavity at different locations on the mold cavity topography prior to forming imitation stone material in the mold cavity to replicate colors of each natural stone at different topography heights of the natural stone; and
forming an imitation stone material in the mold cavity to replicate the topography of each natural stone on the imitation stone material, and transferring the pigments on the surface of the mold topography to the replicated topography on the imitation stone material.

2. The method of claim 1 wherein;
the step of applying pigments at different locations on the mold cavity topography further comprises the step of, applying the pigments at different depths of the mold cavity to replicate different colors at different heights in the natural stone's topography.

3. The method of claim 1 wherein,
the step of forming an imitation stone material in the mold cavity further comprises, molding the imitation stone material in the mold cavity.

4. The method of claim 1 wherein,
the step of applying pigments at different locations on the mold cavity topography further comprises the step of, applying the pigments at different depths of the mold cavity to replicate different colors at different heights in the natural stone's topography; and
the step of forming an imitation stone material in the mold cavity further comprises, molding the imitation stone material in the mold cavity.

5. The method of claim 1 wherein;
the step of shaping a mold cavity with a surface that follows a topography of each of one or more natural stones further comprises, shaping the surface of the mold cavity directly against each natural stone to imbed the natural stone's topography in the surface of the mold cavity.

6. The method of claim 1 comprising:
mapping the surface topography of each natural stone according to different colors at different heights of the topography for determining the different locations on the mold cavity topography on which to apply the pigments of different colors.

7. The method of claim 1 wherein;
the step of applying pigments of different colors at different topography locations of the mold cavity topography further comprises the steps of;
applying a pigment to areas of deepest heights of mold topography, followed by wiping the first pigment from areas of shallower heights of the mold topography; and
applying successive pigments, in turn, to areas of successively shallower heights of the mold topography and wiping the successive pigments, in turn, from all but the deepest of the successively shallower heights of the mold topography, thereby resulting in different pigments at different heights of the mold topography.

8. A method for manufacturing imitation stone, comprising:
shaping a mold die over one or more actual stones to provide a mold cavity having a mold cavity topography, and to transfer a topography of each actual stone to the mold cavity topography;
removing each actual stone from the mold cavity;
applying pigments of different colors at different topography depths of the mold cavity topography to replicate colors at different topography depths of each actual stone; and
replicating each actual stone and replicating the colors at different topography depths of each actual stone, by molding a moldable material in the mold cavity, while transferring the mold cavity topography to the moldable material, and while transferring the pigments of different colors to the moldable material.

9. The method of claim 8, wherein applying pigments of different colors at different topography depths of the mold cavity topography comprises the step of applying a pigment to areas of deepest height of mold topography, followed by wiping the first pigment from areas of shallower heights of the mold topography; and
applying successive pigments, in turn, onto areas of successively shallower heights of the mold topography and wiping the successive pigments, in turn, from all but the deepest of the successively shallower heights of the mold topography, thereby resulting in different pigments at different heights of the mold topography.

10. A mold die comprising:
a mold cavity in the mold die to form imitation stone material;
a surface of the mold cavity having a replicating topography shaped by one or more actual stones; and
different pigments on areas at different heights on the replicating topography for transfer to the imitation stone material, wherein the different pigments replicate different colors on the topography of each actual stone.

11. The mold die of claim 10, further comprising:
a recess in the mold cavity to form the imitation stone material into an imitation mortar joint.
